(19) United States
(12) Patent Application Publication
(10) Pub. No.: US 2026/0070188 A1
(43) Pub. Date: Mar. 12, 2026

(54) POLISHING MATERIAL FILTRATION SYSTEM AND RELATED METHODS

(71) Applicant: Taiwan Semiconductor Manufacturing Company Limited, Hsin-Chu (TW)

(72) Inventors: Tzu-Kang LIAO, Taoyuan City (TW); Feng-An YANG, Hsinchu City (TW); Shun Chan TENG, Hsinchu County (TW); I-Chen CHIANG, Hsinchu City (TW); Yen-Cheng LAI, Hsinchu City (TW); Yi-Lung CHUNG, Hsin-Chu (TW)

(21) Appl. No.: 18/829,389

(22) Filed: Sep. 10, 2024

(51) Int. Cl. B24B 57/00; B01D 29/11

(52) U.S. Cl. CPC B24B 57/00; B01D 29/114; B01D 2221/14

(57) ABSTRACT

A method is provided. The method includes: flowing chemical mechanical polishing (CMP) slurry into a filter assembly, the filter assembly including a filter element extending along a filter element axis, the flowing being via an inlet defined in a body of the filter assembly and located at a first location adjacent a first end of the filter element, the inlet extending along an inlet axis non-parallel to the filter element axis; and after flowing the CMP slurry into the filter assembly, flowing the CMP slurry out of the filter assembly via a first outlet, the first outlet defined in the body of the filter assembly and located at a second location adjacent a second end of the filter element, the first outlet extending along a first outlet axis non-parallel to the filter element axis.

### BACKGROUND

Semiconductor devices are formed on, in, and/or from semiconductor wafers, and are used in a multitude of electronic devices, such as mobile phones, laptops, desktops, tablets, watches, gaming systems, and various other industrial, commercial, and consumer electronics. One or more semiconductor fabrication processes are performed to form semiconductor devices on, in, and/or from a semiconductor wafer.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a perspective view of a system comprising a polishing apparatus, in accordance with some embodiments.

FIG. 2 illustrates a perspective view of a liquid delivery system comprising a filtration assembly, in accordance with some embodiments.

FIG. 3A illustrates a cutaway perspective view of a filtration apparatus relative to other components of a liquid delivery system, in accordance with some embodiments.

FIG. 3B illustrates a cutaway perspective view of a filtration apparatus relative to other components of a liquid delivery system, in accordance with some embodiments.

FIG. 3C illustrates a cutaway perspective view of a filtration apparatus relative to other components of a liquid delivery system, in accordance with some embodiments.

FIG. 3D illustrates a cutaway perspective view of a filtration apparatus relative to other components of a liquid delivery system, in accordance with some embodiments.

FIG. 3E illustrates a cutaway perspective view of a filtration apparatus in operation relative to other components of a liquid delivery system, in accordance with some embodiments.

FIG. 3F illustrates a plan view of a filtration apparatus relative to other components of a liquid delivery system, in accordance with some embodiments.

FIG. 3G illustrates a plan view of a filtration apparatus relative to other components of a liquid delivery system, in accordance with some embodiments.

FIG. 4 illustrates a graph view of a distribution of particles in a processing liquid, in accordance with some embodiments.

FIG. 5 illustrates a plan view of a filtration apparatus in operation, in accordance with some embodiments.

FIG. 6 illustrates a diagrammatic perspective view of a portion of a liquid supply system, in accordance with some embodiments.

FIG. 7 illustrates a schematic view of a slurry delivery monitoring system, in accordance with some embodiments.

FIG. 8 is a flow diagram illustrating a method of operating a filtration apparatus and/or a slurry delivery monitoring system, in accordance with some embodiments.

FIG. 9 is a flow diagram illustrating a method, in accordance with some embodiments.

FIG. 10 is a flow diagram illustrating a method, in accordance with some embodiments.

FIG. 11 illustrates an example computer-readable medium wherein processor-executable instructions configured to embody one or more of the provisions set forth herein may be comprised, according to some embodiments.

### DETAILED DESCRIPTION

The following disclosure provides several different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

Further, spatially relative terms, such as “beneath,” “below,” “lower,” “above,” “upper” and the like, may be used herein for ease of description to describe one element or feature's relationship to other element(s) or feature(s) as illustrated in the figures. The spatially relative terms are intended to encompass different orientations of the device in use or operation in addition to the orientation illustrated in the figures. The apparatus may be otherwise oriented (rotated 90 degrees or at other orientations) and the spatially relative descriptors used herein may likewise be interpreted accordingly.

The term “overlying” and/or the like may be used to describe one element or feature being vertically coincident with and at a higher elevation than another element or feature. For example, a first element overlies a second element if the first element is at a higher elevation than the second element and at least a portion of the first element is vertically coincident with at least a portion of the second element.

The term “underlying” and/or the like may be used to describe one element or feature being vertically coincident with and at a lower elevation than another element or feature. For example, a first element underlies a second element if the first element is at a lower elevation than the second element and at least a portion of the first element is vertically coincident with at least a portion of the second element.

The term “over” may be used to describe one element or feature being at a higher elevation than another element or feature. For example, a first element is over a second element if the first element is at a higher elevation than the second element.

The term “under” may be used to describe one element or feature being at a lower elevation than another element or feature. For example, a first element is under a second element if the first element is at a lower elevation than the second element.

With progress in chemical mechanical polishing (CMP), removal of large-diameter particles from CMP slurry to avoid scratches is increasingly beneficial. Vertical filters are struggling to overcome low filtration efficiency and particle diameter bottlenecks. For example, via a combined analysis of flow field software simulations and actual slurry filtration examples, it is found that vertical filtration is prone to producing a vertical filtration flow field that results in large particles being introduced into a filter element of the vertical filter, causing blockage of the filter element, and reduced filtration performance. The filter element captures the large particles in the grinding liquid and the large particles can be dislodged after the filter element reaches adsorption saturation.

Embodiments of the disclosure generate a spiral sweeping flow field in base slurry flowing through a filtration apparatus including a vertical filter element. Inlet and outlet fluid positions defined in a filter housing are arranged to eliminate the vertical flow field while generating the spiral sweeping flow field. The spiral inertial force throws large particles outward, making the large particles easier to remove via the outlet. The large particles are returned to the base slurry storage tank to improve filtration efficiency and reduce large particles in the polishing slurry. Spiral sweeping flow filtration extends service life of the filter element. A filter element backwash function is also included to clean the filter element to achieve improved flow rate of filtered base slurry out of the filtration apparatus.

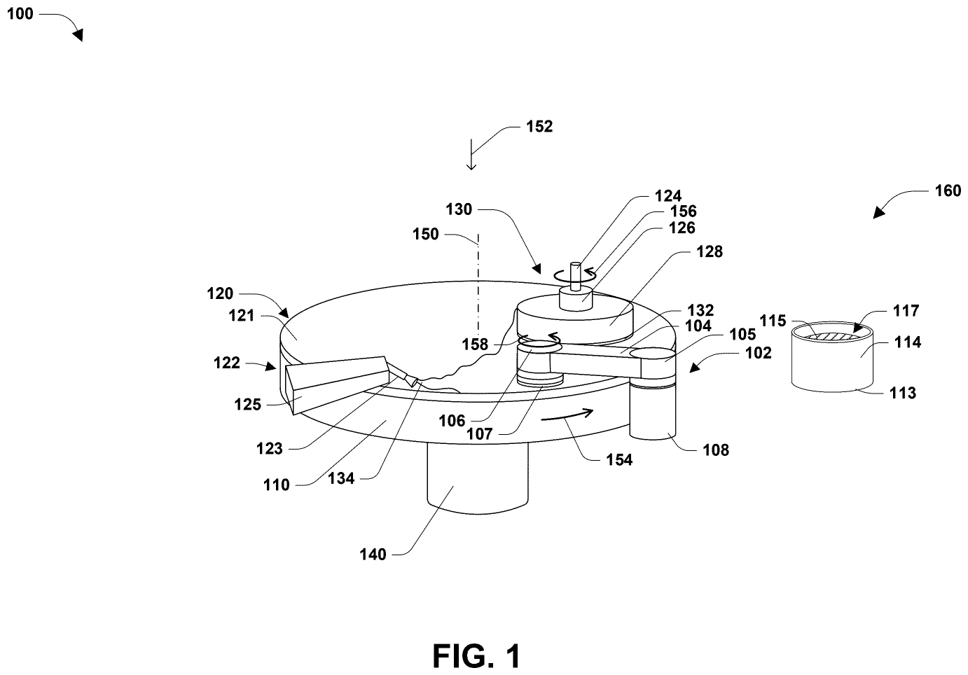

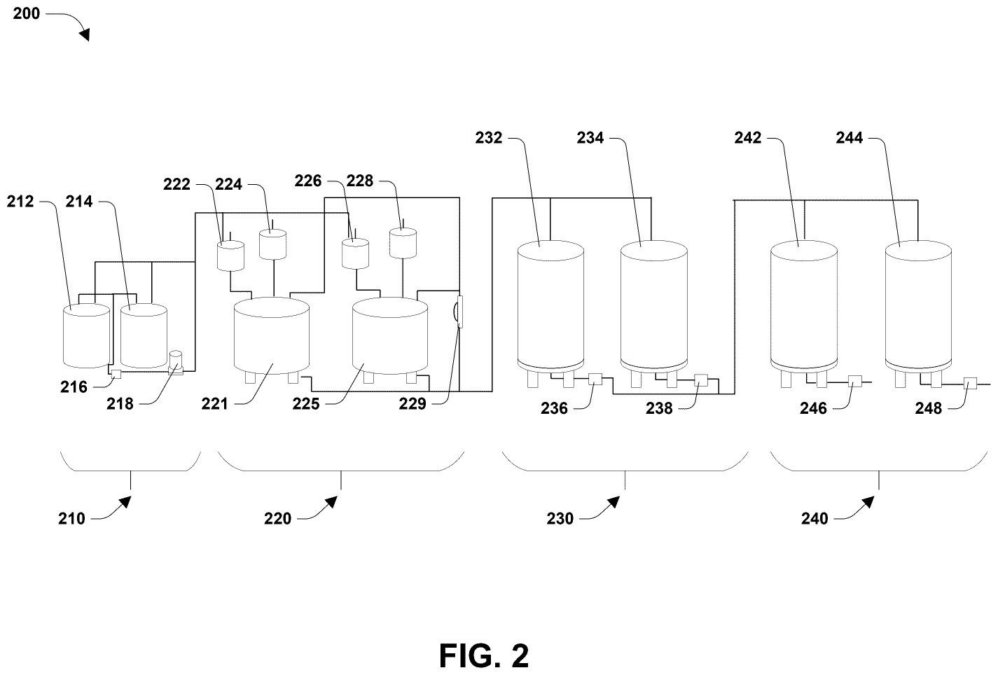

FIG. 1 illustrates a system 100 comprising a polishing apparatus 160, according to some embodiments. FIG. 2 illustrates a liquid supply system (or “base slurry supply system,” “slurry supply system” or “system”) 200 that can supply slurry to the system 100, according to some embodiments. In some embodiments, the polishing apparatus 160 is configured to perform a first polishing process to polish a first semiconductor wafer 132. In some embodiments, the first polishing process comprises a chemical mechanical planarization (CMP) process. In some embodiments, the polishing apparatus 160 comprises a CMP tool. In some embodiments, the first polishing process is performed to homogenize and/or planarize a first surface of the first semiconductor wafer 132 using a combination of chemical and mechanical forces. Embodiments are contemplated in which items different than a semiconductor wafer are polished using the polishing apparatus 160. The polishing system 100 and liquid supply system 200 are described in detail herein to provide context for understanding embodiments of a polishing material filtering (or “filtration”) system and related methods that are described with reference to FIGS. 2-11.

In some embodiments, the polishing apparatus 160 comprises at least one of a platen 110 configured to support a polishing pad 120, the polishing pad 120 configured to be rotated by the platen 110, a polish head 130 configured to support the first semiconductor wafer 132 in a polishing position relative to a polishing surface 121 of the polishing pad 120 for polishing of the first semiconductor wafer 132, a pad conditioner 102 configured to condition the polishing pad 120, or a slurry provider 122 configured to provide a slurry 134 to the polishing surface 121 of the polishing pad 120. The slurry 134 may also be referred to as a “polishing material,” and while typically a slurry, may also be another suitable liquid polishing material or composition that is capable of being filtered. FIG. 1 depicts the first semiconductor wafer 132 in the polishing position in accordance with some embodiments.

In some embodiments, the first semiconductor wafer 132 comprises at least one of a substrate, a photomask, a semiconductor device, a dielectric layer, an epitaxial layer, a silicon-on-insulator (SOI) structure, a semiconductor layer, a conductive material layer, a die, etc. The first semiconductor wafer 132 comprises at least one of silicon, germanium, carbide, arsenide, gallium, arsenic, phosphide, indium, antimonide, SiGe, SiC, GaAs, GaN, GaP, InGaP, InP, InAs, InSb, GaAsP, AlInAs, AlGaAs, GaInAs, GaInP, GaInAsP, or other suitable material. The first semiconductor wafer 132 comprises at least one of monocrystalline silicon, crystalline silicon with a <100> crystallographic orientation, crystalline silicon with a <110> crystallographic orientation, crystalline silicon with a <111> crystallographic orientation or other suitable material. Other structures and/or configurations of the first semiconductor wafer 132 are within the scope of the present disclosure. In some embodiments, the first polishing process performed using the polishing apparatus 160 polishes the first surface of the first semiconductor wafer 132 comprising at least one of a surface of the substrate, a surface of the photomask, a surface of the semiconductor device, a surface of the dielectric layer, a surface of the epitaxial layer, a surface of the SOI structure, a surface of the semiconductor layer, a surface of the conductive material layer, etc.

In some embodiments, the polishing pad 120 is configured to be driven by the platen 110 to rotate in a first rotational direction 154 about an axis 150. In some embodiments, the polishing pad 120 and the platen 110 rotate synchronously in the first rotational direction 154 about the axis 150. In some embodiments, the platen 110 is rotated using a first driving mechanism (not shown), such as a motor configured to drive a cylinder 140 coupled to the platen 110, to rotate the polishing pad 120 about the axis 150.

In some embodiments, the slurry provider 122 comprises at least one of a slurry provider arm 125 or a slurry outlet 123. In some embodiments, the slurry outlet 123 comprises a nozzle. In some embodiments, the slurry provider arm 125 controls a position of the slurry outlet 123 relative to the polishing surface 121 while providing the slurry 134 to the polishing surface 121 of the polishing pad 120. In some embodiments, the slurry provider 122 is connected to a slurry supply system 200 described with reference to FIGS. 2-6. The slurry supply system 200 contains the slurry 134, which is conducted from the slurry supply system 200 to the slurry outlet 123 for application to the polishing pad 120. In some embodiments, the slurry 134 comprises a liquid comprising at least one of one or more polishing particles or one or more reactive chemicals.

The slurry 134 may include one or more of a slurry base liquid, a diluting liquid and additive liquids that are mixed in a mixing container prior to delivery to the slurry outlet 123. As will be set out in greater detail below, the slurry base liquid may include working or “polishing” particles (or “first particles”) and large particles (or “second particles”). The working particles are smaller than the large particles and are of a size beneficial to polish the first surface of the first semiconductor wafer 132. The large particles are of a size that can damage the first surface, which can cause degradation of performance or failure of a semiconductor device of the first semiconductor wafer 132. Removal of the large particles is beneficial to improve yield of wafers processed by the system 100.

The polishing pad 120 comprises a porous material, such as porous polyurethane foam. Other materials of the polishing pad 120 are within the scope of the present disclosure. In some embodiments, a hardness of the polishing pad 120 is at least one of (i) harder than a first threshold hardness to allow at least one of the polishing pad 120 or the slurry 134 to polish, such as mechanically and/or chemically polish, the first surface of the first semiconductor wafer 132, or (ii) softer than a second threshold hardness to mitigate scratching the first surface of the first semiconductor wafer 132. In some embodiments, the polishing pad 120 is removably coupled to the platen 110. In some embodiments, the polishing pad 120 is coupled to the platen 110 using an adhesive.

In some embodiments, the polish head 130 comprises at least one of a wafer holder 128, a polish head cylinder 124, or a wafer holder union 126 between the wafer holder 128 and the polish head cylinder 124. In some embodiments, the polish head 130 exerts a wafer polishing force onto the first semiconductor wafer 132 in a direction 152 towards the polishing pad 120. In some embodiments, the direction 152 of the wafer polishing force is about parallel to the axis 150. In some embodiments, when the first semiconductor wafer 132 is in the polishing position relative to the polishing surface 121, the first semiconductor wafer 132 is in contact with the polishing surface 121. In some embodiments, the polish head 130 is configured to rotate at least one of the wafer holder 128 or the first semiconductor wafer 132 in a second rotational direction 156. In some embodiments, the first rotational direction 154 and the second rotational direction 156 are the same rotational direction (e.g., clockwise or counterclockwise). Embodiments are contemplated in which the first rotational direction 154 and the second rotational direction 156 are different rotational directions (e.g., one is clockwise and the other is counterclockwise). In some embodiments, the first semiconductor wafer 132 is rotated by the polish head 130 using a second driving mechanism (not shown), such as a motor configured to drive the polish head cylinder 124.

In some embodiments, during the first polishing process, at least one of (i) the slurry provider 122 provides the slurry 134 to the polishing surface 121, (ii) the first semiconductor wafer 132 and the polishing pad 120 are rotated, or (iii) the slurry 134 flows between the first semiconductor wafer 132 and the polishing pad 120 as the first semiconductor wafer 132 and the polishing pad 120 are rotated. In some embodiments, the first polishing process polishes the first surface of the first semiconductor wafer 132 by at least one of (i) mechanical force between polishing particles of the slurry 134 and the first surface of the first semiconductor wafer 132, (ii) mechanical force between the polishing pad 120 and the first surface of the first semiconductor wafer 132, or (iii) chemical reaction between reactive chemicals of the slurry 134 and the first surface of the first semiconductor wafer 132.

In some embodiments, the pad conditioner 102 comprises at least one of a pad conditioner arm 104, a pad conditioner head 107, a head carrier 106 configured to hold the pad conditioner head 107, a pad conditioner cylinder 108, or an oscillation component 105 between the pad conditioner arm 104 and the pad conditioner cylinder 108 that enables the pad conditioner cylinder 108 to oscillate the pad conditioner arm 104. In some embodiments, when the pad conditioner 102 is used to condition the polishing pad 120, at least one of the pad conditioner arm 104, the pad conditioner head 107 or the head carrier 106 overlie the polishing pad 120. In some embodiments, the pad conditioner head 107 is in contact with the polishing surface 121 of the polishing pad 120. In some embodiments, the pad conditioner 102 is configured to rotate at least one of the head carrier 106 or the pad conditioner head 107 in a third rotational direction 158. In some embodiments, the first rotational direction 154 and the third rotational direction 158 are the same rotational direction (e.g., clockwise or counterclockwise). Embodiments are contemplated in which the first rotational direction 154 and the third rotational direction 158 are different rotational directions (e.g., one is clockwise and the other is counterclockwise). In some embodiments, the pad conditioner head 107 is rotated using a third driving mechanism (not shown) of the pad conditioner 102, such as a motor configured to rotate the head carrier 106.

In some embodiments, the pad conditioner head 107 is configured to exert a first pad conditioning force onto the polishing pad 120. In some embodiments, the first pad conditioning force is exerted onto the polishing pad 120 in the direction 152 towards the polishing pad 120. In some embodiments, the first pad conditioning force is exerted onto the polishing pad 120 using a fourth driving mechanism (not shown) of the pad conditioner 102, such as a motor configured to move the pad conditioner head 107 in the (downwards) direction 152 and/or a (upwards) direction opposite to the direction 152. The first pad conditioning force is at least one of (i) between about 0 newtons to about 150 newtons, (ii) between about 2 newtons to about 110 newtons, or (iii) between about 1 newton to about 100 newtons. Other values of the first pad conditioning force are within the scope of the present disclosure. In some embodiments, the first pad conditioning force corresponds to a down force of the pad conditioner 102.

In some embodiments, the pad conditioner arm 104 is configured to oscillate the head carrier 106 and the pad conditioner head 107. In some embodiments, the pad conditioner arm 104 oscillates the head carrier 106 and the pad conditioner head 107 using a fifth driving mechanism (not shown) of the pad conditioner 102, such as a motor coupled to the pad conditioner cylinder 108.

In some embodiments, the pad conditioner head 107 performs a first conditioning process to condition at least a first portion of the polishing surface 121 of the polishing pad 120 in which at least one of (i) the pad conditioner head 107 is in contact with the polishing surface 121 of the polishing pad 120, (ii) the pad conditioner head 107 is rotated in the third rotational direction 158, or (iii) the pad conditioner head 107 is oscillated along a first oscillation path (not shown). In some embodiments, the first conditioning process at least one of (i) planarizes at least some of the first portion of the polishing surface 121 using the pad conditioner head 107, (ii) removes contaminants from the first portion of the polishing surface 121 using the pad conditioner head 107, wherein the contaminants comprise at least one of byproducts and/or residue from a semiconductor wafer polished using the polishing pad 120, or byproducts and/or residue from the slurry 134 provided by the slurry provider 122, (iii) removes defects from the first portion of the polishing surface 121 using the pad conditioner head 107, or (iv) removes a portion of the polishing pad 120 to adjust and/or reduce a thickness of at least a portion of the polishing pad 120.

In some embodiments, when the pad conditioner 102 is not being used to condition the polishing pad 120, at least one of the pad conditioner head 107 or the head carrier 106 rest in a resting position relative to a cleaning cup 114. In some embodiments, the cleaning cup 114 defines a chamber 117 in which a liquid 115 is stored. In some embodiments, the liquid 115 comprises at least one of water, de-ionized water, one or more cleaning chemicals, or one or more other suitable substances. In some embodiments, when the pad conditioner head 107 is in the resting position relative to the cleaning cup 114, at least one of (i) the pad conditioner head 107 is in contact with and/or submerged in the liquid 115, or (ii) at least a portion of the pad conditioner head 107 is in the chamber 117 defined by the cleaning cup 114.

FIG. 2 illustrates a perspective view of a liquid supply system 200, in accordance with some embodiments. The liquid supply system 200 can also be referred to as “the system 200.” The system 200 includes a base liquid supply sub-system 210, a mixing sub-system 220, an optional buffer sub-system 230, and a supply sub-system 240.

The base liquid supply sub-system 210 contains and supplies base liquid, which can be a base slurry. The base slurry can be contained in one or more first drums or “slurry drums” 212, 214. The base slurry can be supplied to the mixing sub-system 220 via a pump 216 that pumps the base slurry through a network of pipes that are in fluid communication with the mixing sub-system 220. Prior to entering the mixing sub-system 220, the base slurry is filtered by a filtration apparatus 218. The filtration apparatus 218, in operation, generates filtered base slurry by removing large particles from the base slurry, which is beneficial to improve yield of semiconductor wafers processed by one or more apparatuses that polish the semiconductor wafers using a polishing slurry that includes the filtered base slurry.

The base slurry can include a dispersion of polishing particles in a liquid. In some embodiments, the polishing particles or “abrasives” can include one or more of alumina, ceria, or silica (e.g., SiO₂, CeO₂, or the like) in one or more shapes and one or more sizes. In some embodiments, the size of the polishing particles is a diameter of the polishing particles, such as a maximum diameter of the polishing particles. In some embodiments, the polishing particles have sizes that are in a range of about 1 nanometer (nm) to about 100 nm, such as about 1 nm to about 10 nm, about 10 nm to about 20 nm, or another suitable range. The range of sizes can be selected to be beneficial for polishing a semiconductor wafer surface that has a material composition and feature depths. For example, shallower features may benefit from polishing particles of relatively larger sizes (e.g., about 10 nm to about 20 nm) whereas achieving a planar surface may benefit from polishing particles of sizes below about 10 nm.

In the base slurry, silica and ceria particles may not have well-defined geometric shapes, such as spheres or cubes. The shapes can be irregular and may include nearly spherical shapes, agglomerates, irregular shapes, and the like. The nearly spherical shape can be associated with fumed silica, and particles thereof can have shapes substantially close to spheres that may have some surface imperfections or variations. Agglomerates can be clusters of smaller silica or ceria particles that have bonded together. The size and shape of the agglomerates can vary depending on the manufacturing process and storage conditions of the slurry. The large particles described above may be or include the agglomerates. Irregular shapes can be associated with ceria particles, such as those not synthesized with selection of spherical morphology. The irregular shapes can include faceted structures to somewhat elongated shapes.

Agglomerates in the base slurry can form due to several factors during the manufacturing process or storage. Van Der Waals forces are weak attractive forces between molecules that can cause adjacent silica or ceria particles to stick together, such as in the base slurry that is concentrated. Drying or evaporation of solvent during storage can further promote agglomeration as particles come closer to each other. The surface chemistry of the particles and any additives in the base slurry can influence their interaction. When the surface conditions favor attraction, the particles may clump together. During mixing or agitation of the base slurry, the abrasive particles experience shear forces. The shear forces can be beneficial to improve homogeneity of the base slurry but can also cause the particles to collide and potentially stick together, especially if other factors promote agglomeration. The base slurry may be stored at a selected temperature, such as room temperature. Temperature fluctuations can affect the solubility of additives and the behavior of Van Der Waals forces, thereby increasing agglomeration.

The filtered base slurry exiting the filtration apparatus 218 has a reduced number of agglomerates therein than the base slurry that enters the filtration apparatus 218. The filtered base slurry that exits the filtration apparatus 218 is delivered to the mixing sub-system 220.

The mixing sub-system 220 includes one or more mixing drums 221, 225 in which polishing slurry is formed, aged and stored prior to delivery to one or more of the buffer sub-system 230 and the supply sub-system 240. The mixing sub-system 220 may include one or more component tanks 222, 224, 226, 228 that can store and supply various component materials to the mixing drums 221, 225, respectively. The component tanks 222, 226 may store and supply the filtered base slurry to the mixing drums 221, 225, respectively. The component tanks 224, 228 may store and supply deionized (DI) water to the mixing drums 221, 225, respectively. Additional component tanks may store and supply other component materials, such as pH adjusting additives, oxidizing additives (e.g., H₂O₂), dispersants, biocides, and the like. The mixing sub-system 220 introduces the filtered base slurry and other component materials into the mixing drums 221, 225. The filtered base slurry and the other components materials may form a mixture that is then agitated over a selected period of time referred to as “aging.” Polishing slurry may refer to the aged mixture. The polishing slurry may be transferred from the mixing drums 221, 225 to one or more of the buffer sub-system 230 and the supply sub-system 240. In some embodiments, a feedback assembly or “quality meter” 229 is included in the mixing sub-system 220. The quality meter 229 can perform one or more tests on the mixture in the mixing drums 221, 225, which may include a pH test or other suitable test.

In some embodiments, the mixing sub-system 220 includes one or more feedback assemblies 229. The feedback assembly 229 is positioned between the output of the mixing sub-system 220 that supplies the polishing slurry to the buffer sub-system 230 and inputs of the mixing drums 221, 225. The feedback assembly 229 can include one or more pumps or valves to control flow of the polishing slurry back into the mixing drums 221, 225. The feedback assembly 229 can include one or more filtration sub-assemblies that can remove large particles from the polishing slurry prior to reaching the mixing drums 221, 225. The feedback assembly 229 can include one or more sensors, such as a particle sensor, a pH sensor, or the like, which can obtain polishing slurry data of the polishing slurry. The polishing slurry data may be used to control one or more operations of the system 200.

The buffer sub-system 230 may include one or more buffer tanks or drums 232, 234 that are in fluid communication with the mixing drums 221, 225. The buffer tanks 232, 234 may hold the polishing slurry received from the mixing sub-system 220 prior to delivering the polishing slurry to the supply sub-system 240. Pumps 236, 238 may be disposed to pump the polishing slurry out of the buffer tanks 232, 234, respectively, and into the supply sub-system 240. In some embodiments, the buffer sub-system 230 is not included, such that the supply sub-system 240 is in direct communication with the mixing drums 221, 225. Including the buffer tank (or tanks) 232, 234 between the mixing drums 221, 225 and supply sub-system 240 in the system 200 can offer benefits. The mixing drums 221, 225 can experience variations in mixing intensity or time due to factors like batch size or operator technique. The buffer tanks 232, 234 provide a holding volume where the mixed slurry can undergo additional gentle mixing to improve homogeneity throughout the entire volume. This improves uniformity of distribution of abrasives, additives, and DI water throughout the final polishing slurry used in CMP. The withdrawal of mixture from the mixing drums 221, 225 can cause pulsations or flow rate variations. The buffer tanks 232, 234 can act as reservoirs, dampening the fluctuations and providing improved consistency in flow of the polishing slurry to the supply sub-system 240. Over time, denser abrasive particles in the slurry may settle slightly in the mixing drums 221, 225. The buffer tanks 232, 234 can provide additional holding volume to reduce the settling effect, which can improve consistency of concentration of abrasives throughout the polishing slurry and then during the CMP process. The buffer tanks 232, 234 can act as a buffer against temperature fluctuations that might occur in the mixing drums 221, 225. This can improve uniformity of temperature for the polishing slurry, which can be beneficial for factors like viscosity and dispersant effectiveness. The buffer tanks 232, 234 can provide additional flexibility in the system 200. For example, multiple mixing drums 221, 225 can be used to feed a single buffer tank (e.g., the buffer tank 232), allowing for continuous operation while one drum is refilled or cleaned.

The supply sub-system 240 is in fluid communication with the buffer sub-system 230 and receives the polishing slurry from the buffer sub-system 230. In some embodiments, the supply sub-system 240 includes one or more supply tanks or drums 242, 244. The supply tanks 242, 244 may hold the polishing slurry and may deliver the polishing slurry to one or more CMP apparatuses (e.g., the system 100) in fluid communication therewith. Pumps 246, 248 may be positioned to draw the polishing slurry out of the supply tanks 242, 244, respectively and to push the polishing slurry to the one or more CMP apparatuses.

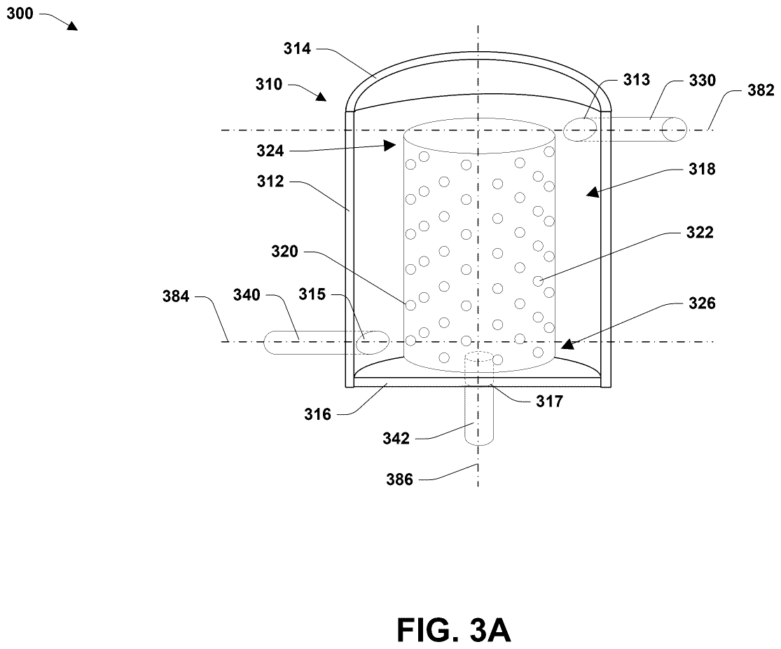

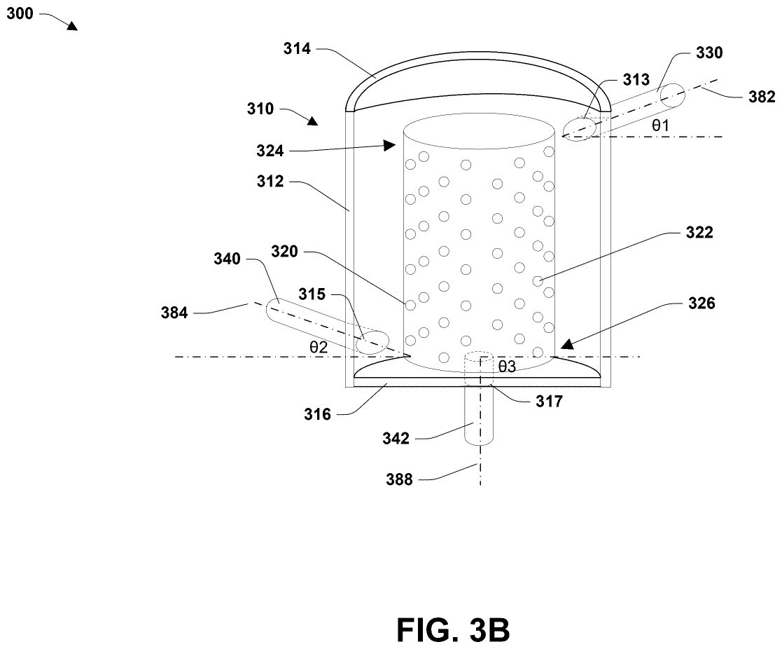

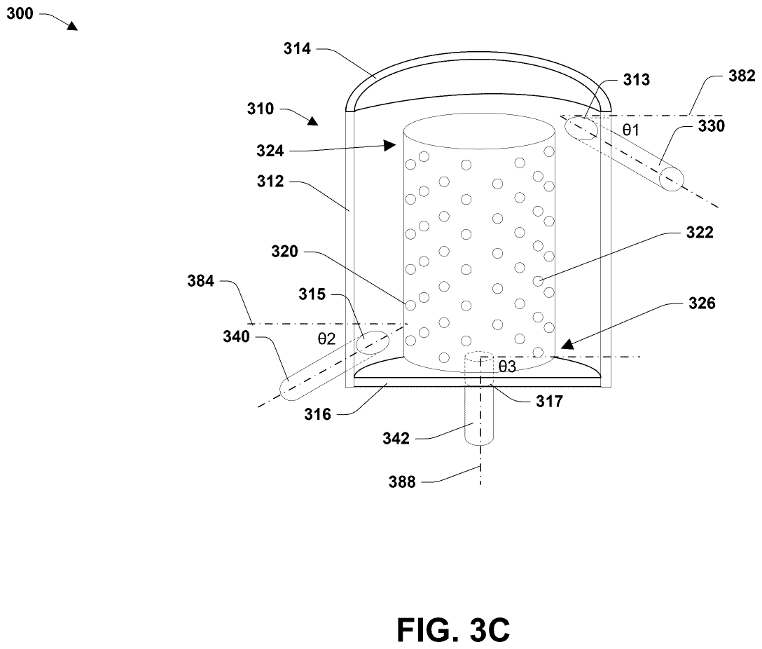

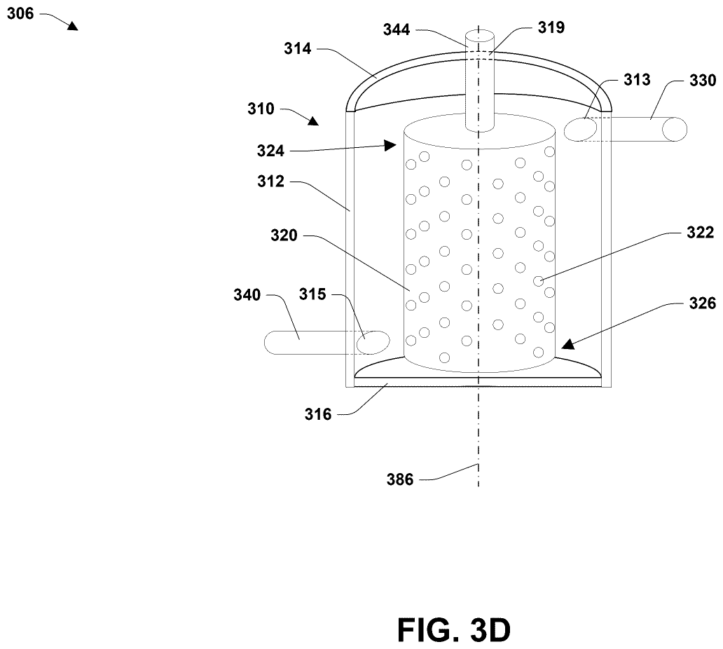

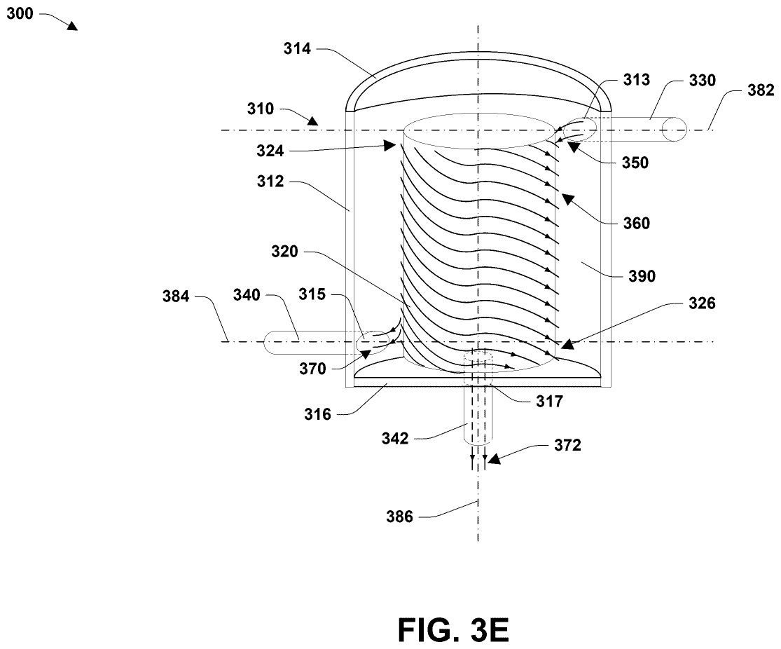

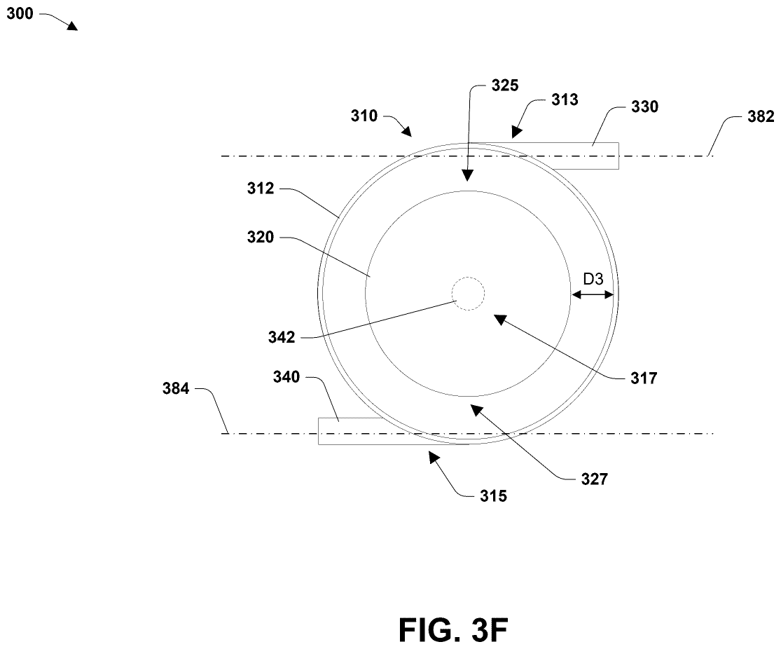

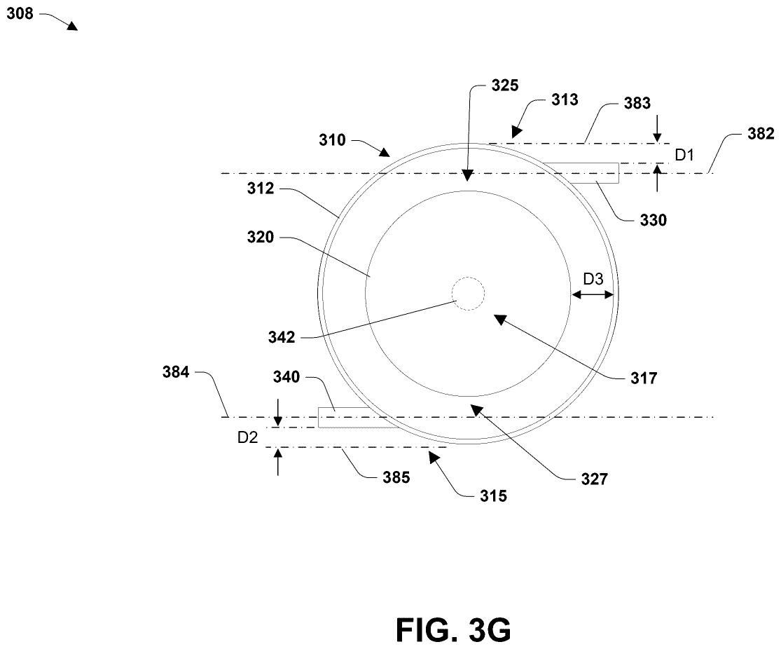

FIGS. 3A-3G illustrate perspective and plan view diagrams of filtration apparatuses 300, 306, 308, according to some embodiments. The filtration apparatuses 300, 306, 308 are embodiments of the filtration apparatus 218 described with reference to FIG. 2. The filtration apparatus 300 can be or include a filter apparatus, a filter, or the like, and may be referred to as the filter apparatus 300 or the filter 300 throughout.

In FIG. 3A, the filtration apparatus 300 includes a housing or “body” 310 and a filter element 320 positioned in the housing 310. One or more transport lines 330, 340, 342 are in fluid communication with the filtration apparatus 300.

The housing 310 includes one or more walls 312, 314, 316, which may be referred to as a “side wall” 312, a “cap” or “cap wall” 314, and a “base” or “base wall” 316, respectively. The wall 316 is a base on which the filter element 320 may be supported. The wall 314 is a cap or lid that overlies the filter element 320 and the wall 316. The wall 312 is a side wall that extends from the wall 314 to the wall 316 and is adjacent the filter element 320 in a horizontal direction. In some embodiments, two of the walls 312, 314, 316 are a single, continuous piece. For example, the walls 312, 314 may be a single, continuous piece that is different than the wall 316. In another example, the walls 312, 316 are a single, continuous piece that is different than the wall 314. The walls 312, 314, 316 of the housing 310 define an opening 318.

The filter element 320 is positioned in the housing 310 in the opening 318. The filter element 320 has length that extends along a filter element axis 386, which may be a vertical axis, as depicted in FIG. 3A. The filter element 320 is operable to capture and hold large particles that are in the base slurry. The filter element 320 may define openings 322 that have diameter smaller than those of the large particles and larger than those of the polishing particles. The openings 322 are depicted not to scale in the view of FIG. 3A for purposes of illustration. In some embodiments, the openings 322 are substantially circular and have diameter in a range of about 1 nm to about 100 nm, though other suitable ranges are contemplated in embodiments herein. For example, the openings 322 may have diameter in a range of about 100 nm to about 120 nm, which may be beneficial to improve passage of the polishing particles therethrough while still catching the large particles therein.

Over time, a portion of the openings 322 may be occupied by large particles, which may degrade flow of the polishing particles through the filter element 320. The large particles positioned in the openings 322 may undergo collisions with other large particles flowing freely in the base slurry, which may cause the large particles in the openings 322 to pass through the openings 322. When the large particles pass through the openings 322, the large particles may flow to the CMP apparatus(es) and damage the semiconductor wafer(s) being polished. The large particles passing through the openings 322 may also damage the filter element 320 by increasing size of the openings 322 or forming nanoscale tears in the material of the filter element 320, thereby degrading ability of the filter element 320 to remove the large particles from the base slurry.

In embodiments of the disclosure, the base slurry arriving at the filtration apparatus 300 is introduced into and removed from the opening 318 of the housing 310 in a manner that generates a spiral sweeping flow field that circles around the filter element 320 without impinging directly thereon. The spiral sweeping flow field is beneficial to improve movement of the large particles away from the filter element 320 and toward the wall 312 due to centrifugal force exerted on the large particles.

The spiral sweeping flow field is generated by number and position of an inlet or “opening” 313 and first and second outlets or “openings” 315, 317 in the housing or “body” 310. In some embodiments, the housing 310 defines the inlet 313 and the first and second outlets 315, 317 therein. The inlet 313 and the first outlet 315 are defined in the wall 312 and the second outlet 317 is defined in the wall 316. The inlet 313 is positioned at a location of the wall 312 proximal the wall 314 and distal the wall 316. The first outlet 315 is positioned at a location of the wall 312 proximal the wall 316 and distal the wall 314. Namely, the inlet 313 is defined in the body 310 of the filter assembly 300 and is located at a first location adjacent a first end 324 (e.g., an upper end) of the filter element 320 and the first outlet 315 is defined in the body 310 of the filter assembly 300 and is located at a second location adjacent a second end 326 (e.g., a lower end) of the filter element 320.

A first transport line 330 is connected to the inlet 313 and is operable to transport base slurry from slurry drum(s) (e.g., the slurry drums 212, 214) to the opening 318. The base slurry is expelled from the first transport line 330 into the opening 318. A second transport line 340 is connected to the first outlet 315 and is operable to transport base slurry from the filter assembly 300 to the slurry drum(s).

The base slurry is drawn out of the opening 318 via the second transport line 340. A third transport line 342 is connected to the second outlet 317 and is operable to transport filtered base slurry out of the filter assembly 300 and to a mixing sub-system (e.g., the mixing sub-system 220). The filtered base slurry is drawn out of the opening 318 via the third transport line 342.

Directionality of flow of the base slurry into and out of the opening 318 via the first and second transport lines 330, 340 may be selected via angling of the first and second transport lines 330, 340 relative to the opening 318. For example, the angling of the first transport line 330 may be selected such that the base slurry is expelled into the opening 318 in a direction shown by a first axis or “inlet axis” 382. In some embodiments, the inlet axis 382 is non-parallel to the filter element axis 386. In some embodiments, the inlet axis 382 is further tangential to the filter element 320. Namely, the inlet axis 382 may be non-intersecting with the filter element 320. In some embodiments, the inlet axis 382 is a horizontal axis, as depicted in FIG. 3A. Namely, the inlet axis 382 may be a horizontal axis and the filter element axis 386 may be a vertical axis, such that the inlet axis 382 and the filter element axis 386 are orthogonal or substantially orthogonal to each other.

In some embodiments, angling of the second transport line 340 may be selected such that the base slurry is drawn out of the opening 318 in a direction shown by a second axis or “first outlet axis” 384. In some embodiments, the first outlet axis 384 is non-parallel to the filter element axis 386. In some embodiments, the first outlet axis 384 is tangential to the filter element 320. Namely, the first outlet axis 384 may be non-intersecting with the filter element 320. In some embodiments, the first outlet axis 384 intersects the filter element 320. In some embodiments, the first outlet axis 384 is a horizontal axis, as depicted in FIG. 3A. Namely, the first outlet axis 384 may be a horizontal axis and the filter element axis 386 may be a vertical axis, such that the first outlet axis 384 and the filter element axis 386 are orthogonal or substantially orthogonal to each other.

The third transport line 342 may be aligned with or substantially aligned with the filter element axis 386 at or near the second outlet 317. Such an alignment may be beneficial to draw the filtered base slurry that is inside the filter element 320 down and out of the opening 318. Due to the centrifugal force described above, the large particles are drawn away from the center of the opening 318 toward the wall 312. The second outlet 317 being positioned at or near the center(s) of the opening 318, the wall 316 and the filter element 320 can be beneficial to reduce number of large particles drawn out by the third transport line 342.

In FIG. 3B, the first and second transport lines 330, 340 are oriented or angled with the filtration apparatus 300 in a manner different from that described with reference to FIG. 3A. Namely, the first transport line 330 may be oriented along the inlet axis 382 that has a first angular offset θ1 from the horizontal axis. The first angular offset θ1 may be such that flow of the base slurry entering the opening 318 via the first transport line 330 may be angled down toward the wall 316 and away from the wall 314. In some embodiments, the first angular offset θ1 is in a range of 0° (e.g., the embodiment depicted in FIG. 3A) to about 45°. Other ranges, such as first angular offsets θ1 that exceed 45°, are contemplated as embodiments herein.

The second transport line 340 may be oriented along the first outlet axis 384 that has a second angular offset θ2 from the horizontal axis. The second angular offset θ2 may be such that flow of the base slurry exiting the opening 318 via the second transport line 340 may be angled up toward the wall 314 and away from the wall 316. In some embodiments, the second angular offset θ2 is in a range of 0° (e.g., the embodiment depicted in FIG. 3A) to about 45°. Other ranges, such as second angular offsets θ2 that exceed 45°, are contemplated as embodiments herein.

The third transport line 344 may be oriented along a second outlet axis 388 that has a third angular offset θ3 from the horizontal axis. In some embodiments, the second outlet axis 388 is the same as or substantially the same as the filter element axis 386 described with reference to FIG. 3A. The second outlet axis 388 may have the third angular offset θ3 that is about 90°, such as in a range of about 60° to about 120°. Other ranges that exceed or are narrower than the stated range are contemplated as embodiments herein.

In FIG. 3C, the first and second transport lines 330, 340 are angled differently than described with reference to FIG. 3B. In some embodiments, the first transport line 330 may be angled such that flow of the base slurry entering the opening 318 is toward the wall 314 and away from the wall 316. In some embodiments, the second transport line 330 may be angled such that flow of the base slurry exiting the opening 318 is away from the wall 314 and toward the wall 316.

It should be understood that the embodiments described with reference to FIGS. 3A, 3B, 3C can be combined. For example, the first transport line 330 may be oriented as described with reference to FIG. 3A and the second transport line 340 may be oriented as described with reference to FIG. 3C. In another example, the first transport line 330 may be oriented as described with reference to FIG. 3B and the second transport line 340 may be oriented as described with reference to FIG. 3C. In some embodiments, angling of the first and second transport lines 330, 340 may be controlled by actuators (not shown) based on electrical control signals generated by a controller (not shown). The angling may be selected by the controller to improve generation of the spiral sweeping flow field in the opening 318.

FIG. 3D depicts the filtration apparatus 306 that is similar in most respects to the filtration apparatus 300 described with reference to FIGS. 3A, 3B, 3C. In some embodiments, the filtration apparatus 306 has a second outlet 319 that is defined in the wall 314 instead of or in addition to the second outlet 317 defined in the wall 316. A third transport line 344 is connected to the second outlet 319. The second outlet 319 may be aligned with the center(s) of the wall 314, the wall 316, and the filter element 320. The third transport line 344 may be oriented or substantially oriented along the filter element axis 386 described with reference to FIG. 3A.

In some embodiments, in FIG. 3D, when the third transport line 344 is positioned above the filter element 320 relative to the wall 316, the opening 315 may be an inlet and the opening 313 may be an outlet. Namely, the spiral sweeping flow field may spiral upward from the opening 315 adjacent the second end 326 toward the opening 313 adjacent the first end 324.

FIG. 3E depicts generation of a spiral sweeping flow field illustrated by lines 360. The lines 360 may be referred to as the spiral sweeping flow field 360 throughout the description. The spiral sweeping flow field 360 is generated due to flow 350 of the base slurry 390 into the opening 318 via the first transport line 330 being near the first end 324 of the filter element 320 and flow 370 of the base slurry 390 out of the opening 318 via the second transport line 340 being near the second end 326 of the filter element 320. The spiral sweeping flow field 360 is further generated due to the first transport line 330 being oriented to expel the base slurry 390 in the direction that is tangential to or non-intersecting with the filter element 320. The spiral sweeping flow field 360 may further be generated due to the second transport line 340 being oriented to draw the base slurry 390 in the direction that is tangential to or non-intersecting with the filter element 320. The spiral sweeping flow field 360 of the base slurry 390 in the opening 318 acts to draw large particles outward away from the filter element 320 and toward the wall 312. The large particles are then drawn out of the opening 318 via the second transport line 340. In some embodiments, the spiral sweeping flow field 360 is substantially uniform along length of the filter element 320 (e.g. in the direction of the filter element axis 386). The improved uniformity is a benefit of positioning the inlet 313 and the outlet 315 at different ends of the filter element 320 as described with reference to FIG. 3A.

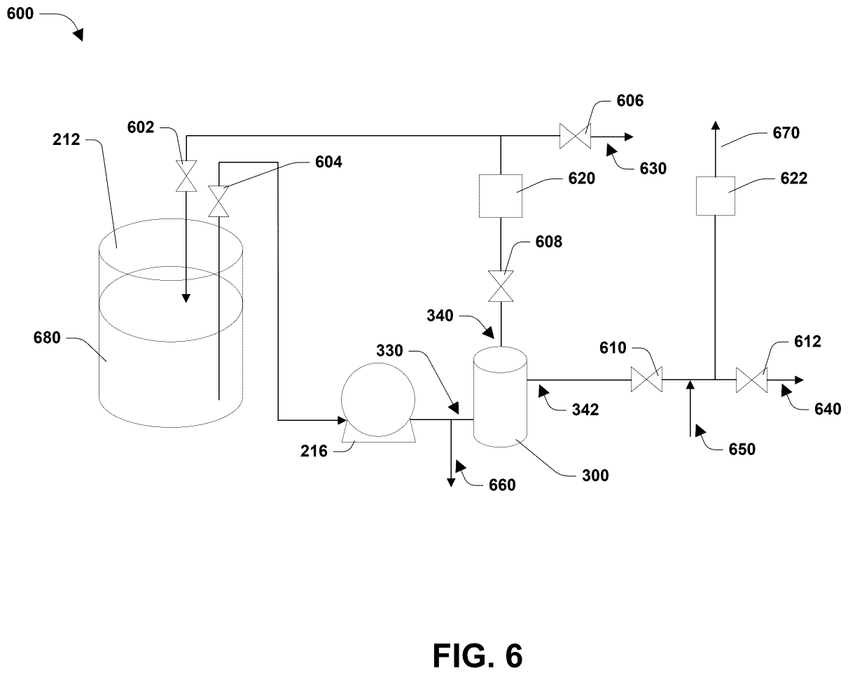

In some embodiments, flow rates of the base slurry 390 through the first and second transport lines 330, 340 and flow rate of the filtered base slurry through the third transport line 342 are selected to be beneficial to generate the spiral sweeping flow field 360. In some embodiments, first flow rate of the base slurry 390 through the first transport line 330 is in a range of about 10 liters per minute (LPM) to about 12 LPM, second flow rate of the base slurry 390 through the second transport line 340 is in a range of about 9 LPM to about 11 LPM, and third flow rate of the filtered base slurry through the third transport line 342 is in a range of about 1 LPM to about 4 LPM. Generally, the first flow rate exceeds the second flow rate, which exceeds the third flow rate. Other ranges that are above or below the stated ranges for the first, second and third flow rates are also contemplated as embodiments herein. One or more of the first, second and third flow rates can be selected via valves described with reference to FIG. 6.

FIG. 3F illustrates a plan view diagram of the filtration apparatus 300, according to some embodiments. The housing 310 of the filter assembly 300 may have circular profile in the plan view. The filter element 320 may have circular profile in the plan view. In some embodiments, the filter element 320 and the housing 310 may be aligned in the plan view. For example, the center of the housing 310 and the center of the filter element 320 may be the same. The side wall 312 of the housing 310 may be offset from the filter element 320 by a distance D3. Due to the spiral sweeping flow field of the base slurry, the large particles are present in higher concentration at a distance from the side wall 312 that is less than the distance D3.

As depicted in FIG. 3F, in addition to being located on opposite sides of the filter element 320 in the vertical axis direction as described with reference to FIG. 3A, the inlet 313 and the first outlet 315 are located on opposite sides of the filter element 320 along a horizontal direction, in some embodiments. For example, the inlet 313 may be positioned adjacent a first side 325 of the filter element 320 and the first outlet 315 may be positioned adjacent a second side 327 of the filter element 320. Positioning the inlet 313 and the first outlet 315 as just described can be beneficial to generate the spiral sweeping flow field described with reference to FIG. 3E.

FIG. 3G illustrates a plan view diagram of a filtration apparatus 308, according to some embodiments. The filtration apparatus 308 is similar in most respects to the filtration apparatus 300. In some embodiments, one or both of the first and second transport lines 330, 340 is offset from a corresponding tangential axis 383, 385 by a corresponding distance D1, D2, respectively. For example, a side wall of the first transport line 330 may be offset from the tangential axis 383 by the first distance D1. In another example, a side wall of the second transport line 340 may be offset from the tangential axis 385 by the second distance D2. The first and second distances D1, D2 may be the same as or different than each other. In some embodiments, each of the first and second distances D1, D2 may be in a range of about zero (e.g., the embodiments depicted in FIG. 3F) to about half a separation distance D3 between the filter element 320 and the wall 312. When the range exceeds half the distance D3, the flow of the base slurry 390 into the opening via the inlet 313 may intersect the filter element 320, which can result in degradation of the filter element 320 due to adsorption of the large particles therein.

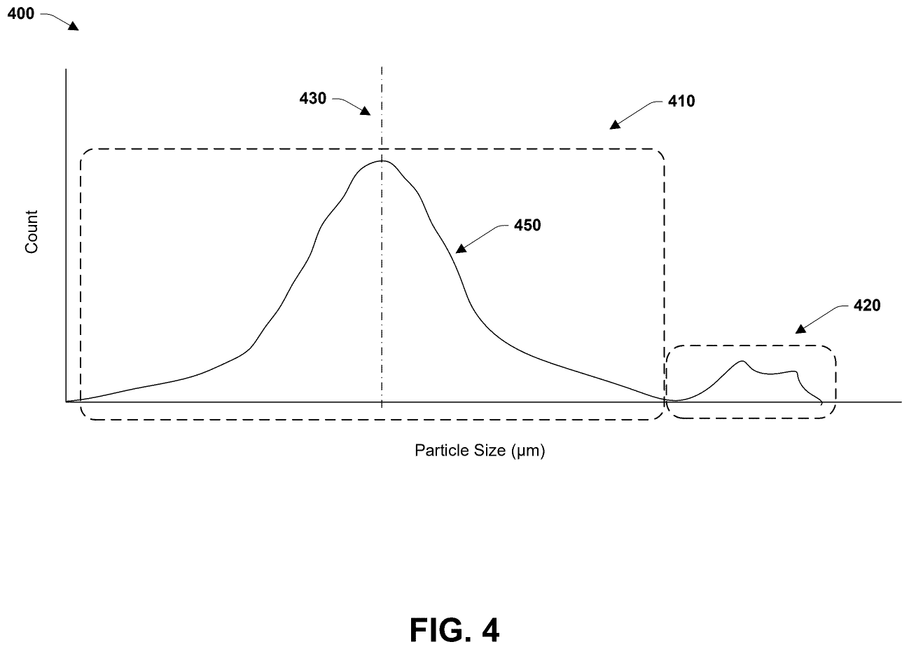

FIG. 4 depicts a graph view of a distribution 400 of particles in a base slurry, according to some embodiments. As described with reference to FIGS. 1-3G, the base slurry may include large particles, which may be agglomerates of polishing particles (or “working particles”). The distribution 400 may have a horizontal axis that is associated with particle size and a vertical axis that is associated with count of particles. The distribution 400 may include a line 450 that depicts the count of particles associated with each particle size. The line 450 may include two groups 410, 420. A first group 410 is associated with polishing particles and a second group 420 is associated with large particles. The first group 410 may include a peak value 430 that represents a particle size having the highest count. In some embodiments, at least one of the particle sizes among the second group 420 may exceed about twice the particle size associated with the peak value 430 of the first group 410.

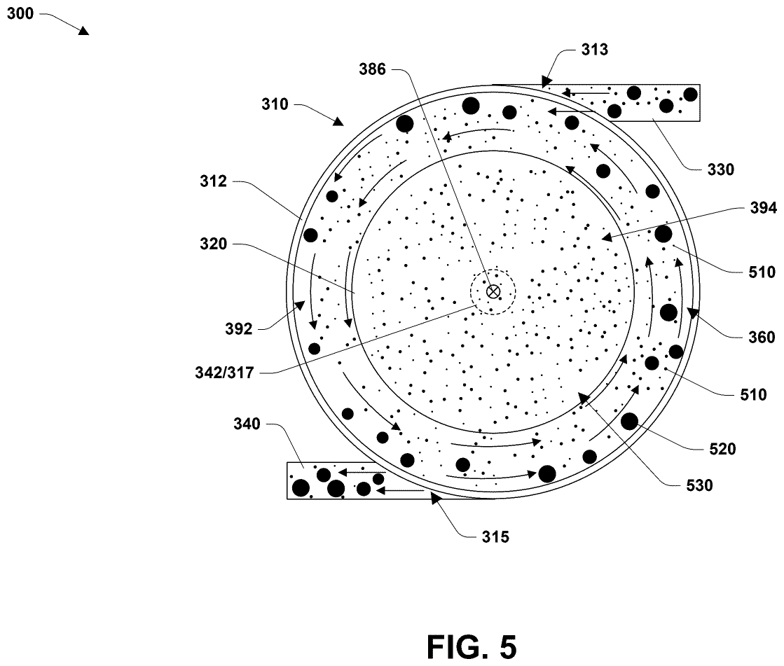

FIG. 5 illustrates a plan view of the filtration apparatus 300 in operation, in accordance with some embodiments. As depicted in FIG. 5, the spiral sweeping flow field 360 generated as a result of positioning of the inlet 313 relative to that of the first outlet 315 pushes large particles 520 toward the wall 312 and away from the filter element 320. The spiral sweeping flow field 360 reduces number of large particles 520 in an opening 530 defined by the filter element 320 while number of polishing particles 510 in the opening 530 may be maintained, slightly decreased or somewhat increased. For example, the spiral sweeping flow field 360 may also push the polishing particles 510 toward the wall 312 and away from the filter element 320, but the polishing particles 510 may be pushed outward to a significantly lesser degree than the large particles 520 are. It should be noted that that the particles 510, 520 are shown in FIG. 5 not to scale for purposes of illustration.

In FIG. 5, a first portion of the base slurry that is near an outer side or region of the spiral sweeping flow field 360 may be referred to as a “first base slurry 392” and may have higher concentration of large particles. The outer region may extend from the side wall 312 inward to a first position that is between the side wall 312 and the filter element 320. Namely, the outer region does not extend to the filter element 320, which is beneficial to avoid large particles 520 passing into or through the filter element 320. A second portion of the base slurry that is near an inner side or region or center of the spiral sweeping flow field 360 may be referred to as a “second base slurry 394” and may have lower concentration of large particles, a higher concentration of polishing or working particles, or both. The inner region may be inside the filter element 320 in the plan view. In some embodiments, the inner region can extend from the center of the filter element 320 to a second position slightly nearer the center than the first position. The second position may be outside the filter element 320. In some embodiments, first concentration of large particles in the first base slurry 392 may exceed second concentration of large particles in the second base slurry 394 by a multiple in a range of about 5 to about 1,000,000. Namely, the number of large particles in the second base slurry 394 near the center of the spiral sweeping flow field 360 that exits via the second outlet 317 may be less than the number of large particles in the first base slurry 392 near the outer side of the spiral sweeping flow field 360 that exits via the first outlet 315 by a factor of about 5 to a factor of about 1,000,000. Other ranges of the factors within the stated range are also contemplated as embodiments herein. In one non-limiting example, experimental results when using the spiral-type cross-flow filtration apparatus 300 include a reduction of first large particles having diameter exceeding about 0.9 micrometers (um) by about 85% and a reduction of second large particles having diameter exceeding about 0.2 um by about 93%. In some embodiments, first concentration of large particles in the first base slurry 392 may exceed second concentration of large particles in the second base slurry 394 by a multiple in a range of about 6.6 to about 14.3.

FIG. 6 illustrates a diagrammatic view of a base slurry supply sub-system 600, according to some embodiments. The base slurry supply sub-system 600 is an embodiment of the base liquid supply sub-system 210 described with reference to FIG. 2 and like reference numerals refer to like elements. A single slurry drum 212 is depicted in FIG. 6, but two or more slurry drums 212, 214 may be included as described with reference to FIG. 2.

In FIG. 6, the base slurry supply sub-system 600 includes the slurry drum 212, the pump 216, the filter 300 (which may be the filtration apparatus 218), valves 602, 604, 606, 608, 610, 612, first and second flow meters 620, 622, drains 640, 660, outlet 670 and supply line 650. The slurry drum 212 holds and supplies base slurry 680, which is similar in most respects to the base slurry described with reference to FIG. 2.

Each of the valves 602, 604, 606, 608, 610, 612 may be or include one or more of a ball valve including an actuator, a solenoid valve, or a diaphragm valve including a solenoid. Generally, the valves 602, 604, 606, 608, 610, 612 may be controlled manually (e.g., by a human operator), electronically, or both.

The valve 604 is positioned between the slurry drum 212 and the pump 216 and can control flow of the base slurry 680 from the slurry drum 212 to the pump 216.

The valve 610 is positioned between the filtration apparatus 300 and the outlet 670 and can control flow of the base slurry 680 from the filtration apparatus 218 to the mixing sub-system 220.

The valves 602, 608 are positioned between the filtration apparatus 218 and the slurry drum 212 and control flow of the base slurry 680 expelled from the filtration apparatus 300 back to the slurry drum 212.

The valve 608 may be positioned between the second transport line 340 and the slurry drum 212, and the valve 610 may be positioned between the third transport line 342 and the mixing sub-system 220. As just described, the valves 608, 610 may be controlled to select flow rate of the base slurry 680 through the second transport line 340 and flow rate of the filtered base slurry through the third transport line 342. Selection of the stated flow rates can be used to generate the spiral sweeping flow field that is beneficial based on pore size of the filter element 320. The selection of the flow rates may be based on the pore size, which may be stored in a database or other suitable computer-readable medium. In some embodiments, selection of valve opening size of the valves 608, 610 may be performed based at least on one or more measurements of the first and second flow meters 620, 622 positioned adjacent the valves 608, 610.

The first flow meter 620 is positioned between the valve 608 and the valve 602 and can measure flow rate of the flow of the base slurry 680 expelled from the filtration apparatus 300 back to the slurry drum 212. Output of the first flow meter 620 may be received by a controller (not shown) that can determine efficacy of the filter element 320 based on the flow rate measured by the first flow meter 620. For example, as the filter element 320 adsorbs the large particles, the flow rate may decrease. When the decrease in the flow rate exceeds a threshold value, the controller may determine that the filter element 320 is ready for cleaning or replacement. Prior to the threshold value being exceeded, the controller may increase a valve opening size of the valve 608.

The second flow meter 622 is positioned between the valve 610 and the outlet 670 and can measure flow rate of the flow of the base slurry 680 from the filtration apparatus 300 to the mixing sub-system 220. Output of the second flow meter 622 may be received by a controller (not shown) that can determine efficacy of the filter element 320 based on the flow rate measured by the second flow meter 622. For example, as the filter element 320 adsorbs the large particles, the flow rate through the third transport line 342 may decrease. When the decrease in the flow rate exceeds a threshold value, the controller may determine that the filter element 320 is ready for cleaning or replacement. Prior to the threshold value being exceeded, the controller may increase a valve opening size of the valve 610. In some embodiments, the controller may determine that the filter element 320 is ready for cleaning or replacement based on measurements outputted by the first flow meter 620 and the second flow meter 622.

Prior to normal operation in which the base slurry is supplied to the mixing sub-system 220, a pre-wash operation may be performed on the filter element 320. The pre-wash operation may remove old base slurry in the filter element 320 and may reduce clogging of the filter element 320.

The valve 606 is positioned between the valve 608 and the vent 630. During the pre-wash operation, the valve 606 may be opened to expel the old base slurry and particles removed from the filter element 320 by the pre-wash via the vent 630.

The valve 612 is positioned between the valve 610 and the drain 640. During the pre-wash operation, the valve 612 may be opened to expel the old base slurry and particles removed from the filter element 320 or present in transport lines between the filtration apparatus 300 and the drain 640.

In some embodiments, a reverse cleaning or “backflow cleaning” operation can be performed to remove large particles lodged in the filter element 320. One or more of DI or ultrapure water and nitrogen gas may be introduced to the filtration apparatus 300 via the supply line(s) 650 and the valve 610. The dislodged particles, base slurry and ultrapure water and/or nitrogen gas may be expelled through the drain 660 which is positioned between the filtration apparatus 300 and the pump 216. The reverse cleaning may be performed according to a schedule, such as once per day or more frequently.

In some embodiments, the reverse cleaning is performed in response to one or more flow rate measurements generated by the first and second flow meters 620, 622. For example, when one or both of the flow rate measurements is below a threshold value, the reverse cleaning may be performed immediately or may be scheduled for an available time slot based on wafer production scheduling. The threshold value may be associated with a reduced efficacy or “reduced efficacy state” of the filter element 320. For example, an operating flow rate may be selected, such as one of those described with reference to FIG. 3E. As describe previously, the first flow rate of the base slurry 390 through the first transport line 330 can be in a range of about 10 liters per minute (LPM) to about 12 LPM, the second flow rate of the base slurry 390 through the second transport line 340 can be in a range of about 9 LPM to about 11 LPM, and the third flow rate of the filtered base slurry through the third transport line 342 can be in a range of about 1 LPM to about 4 LPM. Taking an example of the second flow rate, the operating flow rate for the second transport line 340 may be selected to be 10 LPM and reduced efficacy can be selected to be a percentage or absolute value below the operating flow rate. In the stated example, the reduced efficacy may be 10% or 1 LPM below the operating flow rate, or 9 LPM. In some embodiments, the reduced efficacy is in a range of about 10% to about 50%, about 20% to about 40%, about 25% to about 35%, or another suitable value. In some embodiments, the reduced efficacy can be below about 10% or about above 50%, such as 5% or 60%. In some embodiments, reverse cleaning or replacement of the filter element 320 is performed in response to the flow rate of the third transport line 342 being below about 1 LPM or decreasing by about 50%.

The reduced efficacy may be selected according to a reduction in the second flow rate and/or the third flow rate that is associated with a concentration of large particles in the filtered base slurry that exceeds a threshold value. For example, the concentration may be in a range of about 10 parts-per-million (PPM) to about 1. Other ranges within the stated range are also contemplated as embodiments herein.

In one non-limiting example, an adjustment in the second flow rate that reduces the second flow rate from about 10 LPM to about 5 LPM can reduce concentration of large particles by about 60%.

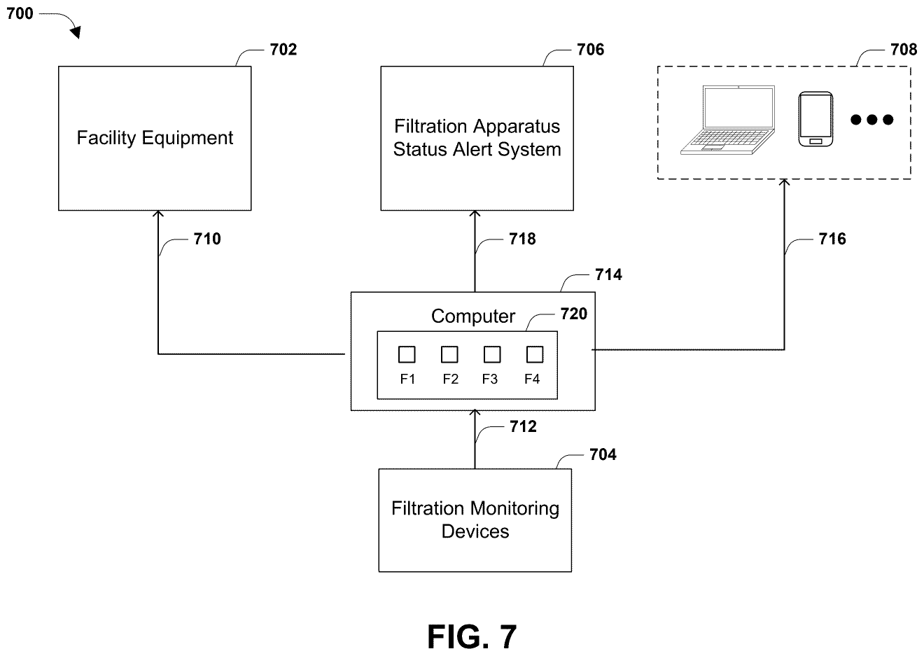

FIG. 7 illustrates a schematic view of a filtration monitoring system (shown with reference number 700), according to some embodiments. The filtration monitoring system 700 comprises at least one of a set of filtration monitoring devices 704, facility equipment 702 of a facility, a computer 714, a filtration apparatus status alert system 706, or one or more client devices 708. The set of filtration monitoring devices 704 comprises filtration monitoring devices distributed at various locations of the facility. The filtration monitoring devices are used to determine measurements associated with filtration apparatuses and/or other equipment in the facility.

In some embodiments, the set of filtration monitoring devices 704 transmit a set of monitoring signals 712 to the computer 714. In some embodiments, each signal of the set of monitoring signals 712 is transmitted by a monitoring device, of the set of filtration monitoring devices 704, in a polishing apparatus of the facility. In some embodiments, the set of filtration monitoring devices 704 comprises at least one of a first set of monitoring devices for the filtration apparatus 300, a second set of monitoring devices for a second filtration apparatus, etc. In some embodiments, the first set of monitoring devices comprises at least one of the first flow meter 620, the second flow meter 622, or one or more other monitoring devices.

In some embodiments, the set of monitoring signals 712 comprises a first monitoring signal from the first flow meter 620. In some embodiments, the first flow meter 620 comprises a wireless communication module that transmits the first monitoring signal to the computer 714 wirelessly. In some embodiments, the first flow meter 620 transmits the first monitoring signal to the computer 714 over a wired connection between the first flow meter 620 and the computer 714. In some embodiments, the first monitoring signal is indicative of the first flow rate associated with the first transport line 330.

In some embodiments, the set of monitoring signals 712 comprises a second monitoring signal from the second flow meter 622. In some embodiments, the second flow meter 622 comprises a wireless communication module that transmits the second monitoring signal to the computer 714 wirelessly. In some embodiments, the second flow meter 622 transmits the second monitoring signal to the computer 714 over a wired connection between the second flow meter 622 and the computer 714. In some embodiments, the second monitoring signal is indicative of the third flow rate associated with the third transport line 342.

In some embodiments, the computer 714 controls a display panel 720 comprising a set of status indicators associated with filtration apparatuses in the facility. In some embodiments, an indicator of the set of status indicators comprises a light, such as an indicator light, that indicates whether a corresponding filtration apparatus is associated with a reduced efficacy, wherein the light being in a first state indicates that the corresponding filtration apparatus is associated with the reduced efficacy and/or the light being in a second state indicates that the corresponding polishing apparatus is not associated with a reduced efficacy. In some embodiments, the display panel 720 comprises a display configured to display an alert indicative of one or more detected potential statuses of one or more filtration apparatuses. In some embodiments, the first state corresponds to a first color emitted by the light, such as red or other color, and the second state corresponds to a second color emitted by the light, such as green or other color. The set of status indicators comprises at least one of a first indicator “F1” associated with the filtration apparatus 300, a second indicator “F2” associated with the second filtration apparatus, a third indicator “F3” associated with a third filtration apparatus, a fourth indicator “F4”associated with a fourth filtration apparatus, or other indicator.

In some embodiments, the computer 714 provides one or more first signals 710 to the facility equipment 702. In some embodiments, the one or more first signals 710 are used to control at least some of the facility equipment 702, such as one, some or all base slurry supply systems of the facility and/or other equipment of the facility. In some embodiments, the one or more first signals 710 are generated using a signal generator of the computer 714. The one or more first signals 710 are indicative of at least one of (i) a set of filtration apparatus statuses comprising at least one of the first filtration apparatus status for the filtration apparatus 300, a second filtration apparatus status for the second filtration apparatus, etc., (ii) a list of filtration apparatuses that are determined to be associated with a reduced efficacy, or (iii) other information. In some embodiments, the computer 714 transmits the one or more first signals 710 to the facility equipment 702 wirelessly, such as using a wireless communication device of the computer 714. In some embodiments, the computer 714 transmits the one or more first signals 710 to the facility equipment 702 over a physical connection between the computer 714 and the facility equipment 702. In some embodiments, the computer 714 transmits the one or more first signals 710 to the valves 608, 610 and the pump 216 that control flow rate of base slurry into and out of the filtration apparatus 300 and control flow field of the base slurry in the filtration apparatus 300.

In some embodiments, the computer 714 transmits a second signal 718 to the filtration apparatus status alert system 706. The second signal 718 is generated using the signal generator of the computer 714. In some embodiments, the second signal 718 is indicative of at least one of (i) the set of filtration apparatus statuses, (ii) the list of filtration apparatuses that are determined to be associated with a reduced efficacy, or (iii) other information. In some embodiments, the computer 714 transmits the second signal 718 to the filtration apparatus status alert system 706 wirelessly, such as using the wireless communication device of the computer 714. In some embodiments, the computer 714 transmits the second signal 718 to the filtration apparatus status alert system 706 over a physical connection between the computer 714 and the filtration apparatus status alert system 706. In some embodiments, the filtration apparatus status alert system 706 triggers an alarm function based upon the second signal 718. In some embodiments, the filtration apparatus status alert system 706 triggers the alarm function based upon the second signal 718 indicating that the filtration apparatus 300 is associated with the reduced efficacy. In some embodiments, in response to triggering the alarm function, an alarm message is displayed via a display of the filtration apparatus status alert system 706. The alarm message comprises at least one of an indication that the filtration apparatus 300 is associated with the reduced efficacy, an indication of a maintenance operation to perform on the filtration apparatus 300 to remedy the reduced efficacy, an indication comprising an instruction for the filtration apparatus 300 to cease operating (until the reduced efficacy is remedied, for example), or other indication. In some embodiments, an alarm sound is output via a speaker connected to the filtration apparatus status alert system 706 in response to triggering the alarm function.

In some embodiments, the computer 714 transmits a third signal 716 to one or more client devices 708. The one or more client devices 708 comprise at least one of a phone, a smartphone, a mobile phone, a landline, a laptop, a desktop computer, hardware, or other type of client device. The third signal 716 is generated using the signal generator of the computer 714. In some embodiments, the third signal 716 is indicative of at least one of (i) the set of filtration apparatus statuses, (ii) the list of filtration apparatuses that are determined to be associated with a reduced efficacy, or (iii) other information. In some embodiments, the computer 714 transmits the third signal 716 to a client device of the one or more client devices 708 wirelessly, such as using the wireless communication device of the computer 714. In some embodiments, the computer 714 transmits the third signal 716 to a client device of the one or more client devices 708 over a physical connection between the computer 714 and the client device. In some embodiments, the third signal 716 comprises a message, such as at least one of an email, a text message, etc., transmitted in response to detecting one or more reduced efficacies associated with one or more polishing apparatuses, such as the first reduced efficacy associated with the filtration apparatus 300. In some embodiments, in response to detecting a reduced efficacy associated with a filtration apparatus, a telephonic call is made to a client device, such as a landline or a mobile phone, of the one or more client devices 708, such as using a dialer of the computer 714.

In some embodiments, the set of monitoring signals 712 are used as feedback based upon which operation of the facility equipment 702 is controlled by the computer 714. In some embodiments, the computer 714 controls operation of the facility equipment 702 based upon measurements provided by the set of monitoring signals 712. In some embodiments, operation of the facility equipment 702 is controlled using the one or more first signals 710. In some embodiments, a signal of the one or more first signals 710 is indicative of one or more instructions.

In some embodiments, the base slurry supply system of the facility equipment 702 at least one of ceases operation, enters a locked state, or performs another operation in response to receiving a signal (of the one or more first signals 710) at least one of (i) indicating that the filtration apparatus 300 is associated with the first potential defect or (ii) indicating an instruction to cease operation, enter the locked state, or perform another operation. In some embodiments, the one or more first signals 710 comprise a signal transmitted to a machine, such as a DI water supply or gas supply. In some embodiments, the signal instructs the machine to perform a maintenance operation on the filtration apparatus 300 to remedy the first potential defect, such as at least one of (i) reverse flow cleaning the filter element 320 of the filtration apparatus 300, (ii) repair and/or refurbish one or more components of the filtration apparatus 300, or (iii) replace one or more components of the filtration apparatus 300 with a replacement component. In some embodiments, the signal allocates one or more resources (e.g., manpower, a robot, one or more tools, the replacement component, etc.) to the filtration apparatus 300 to be used for remedying the first reduced efficacy.

In some embodiments, in response to determining that the filtration apparatus 300 is not associated with reduced efficacy, the filtration apparatus 300 is used to supply base slurry to the mixing sub-system 220 for eventual supply to a polishing apparatus, so as to perform a polishing process on the first semiconductor wafer 132. In some embodiments, in response to determining that the filtration apparatus 300 is associated with the first reduced efficacy, the computer 714 instructs the base slurry supply system 200 to not deliver the base slurry via the filtration apparatus 300 (until the first reduced efficacy is addressed, for example). During the base slurry supply system 200 not delivering the base slurry via the filtration apparatus 300, the base slurry supply system 200 may deliver the base slurry via another filtration apparatus. In some embodiments, during the base slurry supply system 200 not delivering the base slurry via the filtration apparatus 300, the base slurry supply system 200 may halt delivery of the base slurry to the mixing sub-system 220 without stopping polishing of the first semiconductor wafer 132 on the basis that sufficient aged slurry is present in one or more of the buffer tanks 232, 234, one or more of the supply tanks 242, 244, or both.

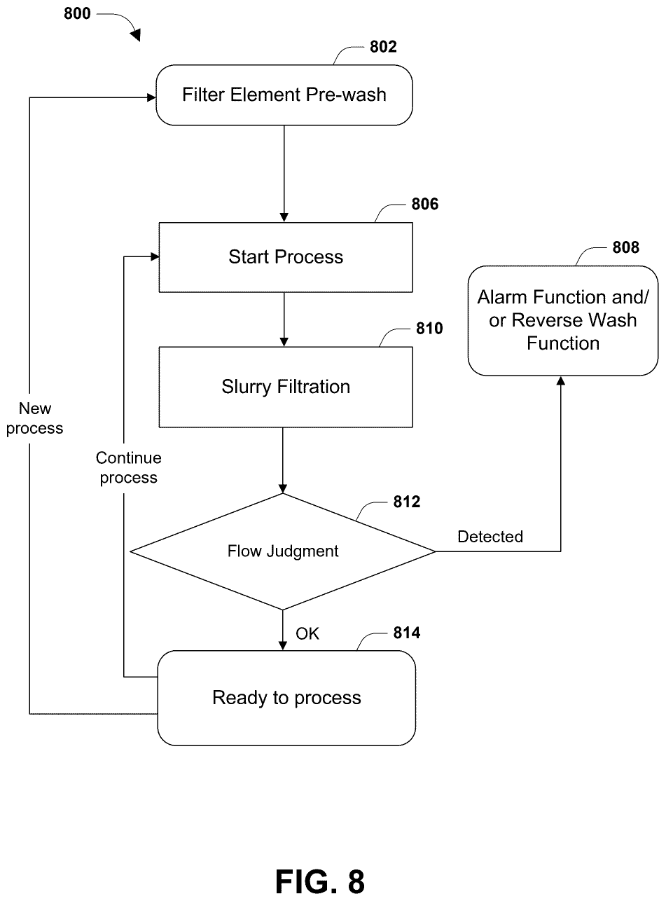

FIG. 8 illustrates a method 800 of operating the base slurry supply system 200 and the slurry delivery monitoring system 700, in accordance with some embodiments. At 802, the filtration apparatus 300 undergoes a filter element pre-washing operation. In some embodiments, the pre-wash operation corresponds to a mode of the base slurry supply system 200 in which at least one of (i) the filtration apparatus 300 is not in production, or (ii) the filter element 320 is moisturized by a liquid, such as at least one of water, de-ionized water, rinsing liquid used in a high pressure (HP) rinse, etc.

In some embodiments, in response to the filtration apparatus 300 undergoing and/or completing the pre-wash operation (and/or entering a second operation from the pre-wash operation), a base slurry supply process 806 is initiated. In some embodiments, the slurry delivery monitoring system 700 initiates the base slurry supply process 806 in response to determining that the filtration apparatus 300 is not associated with reduced efficacy. In some embodiments, the slurry delivery monitoring system 700 initiates the base slurry supply process 806 in response to determining that the filtration apparatus 300 is ready to be used for the base slurry supply process 806. In some embodiments, the base slurry supply process 806 is performed using one or more of the techniques provided herein. In some embodiments, in response to performing at least a portion of the base slurry supply process 806, the filtration apparatus 300 performs slurry filtration 810 to remove large particles from the base slurry prior to delivering the filtered base slurry to the mixing sub-system 220.

In some embodiments, in response to the filtration apparatus 300 performing the slurry filtration 810, the slurry delivery monitoring system 700 performs a flow judgment 812. In some embodiments, the flow judgment 812 comprises at least one of (i) capturing the first flow rate by the first flow meter 620, (ii) capturing the second flow rate by the second flow meter 622, (iii) determining whether the filtration apparatus 300 is associated with reduced efficacy, or (iv) one or more other acts. In some embodiments, in response to determining, via the flow judgment 812, that the filtration apparatus 300 is not associated with a reduced efficacy, the filtration apparatus 300 enters a ready to process state 814. In some embodiments, if the filter element 320 does not need to be replaced or refurbished, the filtration apparatus 300 continues the base slurry supply process 806 after entering the ready to process state 814. In some embodiments, after at least one of (i) the filter element 320 is replaced or refurbished, (ii) after supply of the base slurry has stopped for a selected period of time (e.g., more than 1 hour), (iii) after changing a recipe for the polishing slurry to be supplied to the CMP apparatus, or (iv) another suitable situation, the filtration apparatus 300 enters and/or undergoes pre-washing at 802.

In some embodiments, in response to determining, via the flow judgment 812, that the filtration apparatus 300 is associated with the reduced efficacy, the alarm function and/or reverse cleaning function 808 may be performed to at least one of (i) replace the filter element 320, (ii) refurbish or repair the filter element 320, (iii) reverse cleaning the filter element 320, etc.

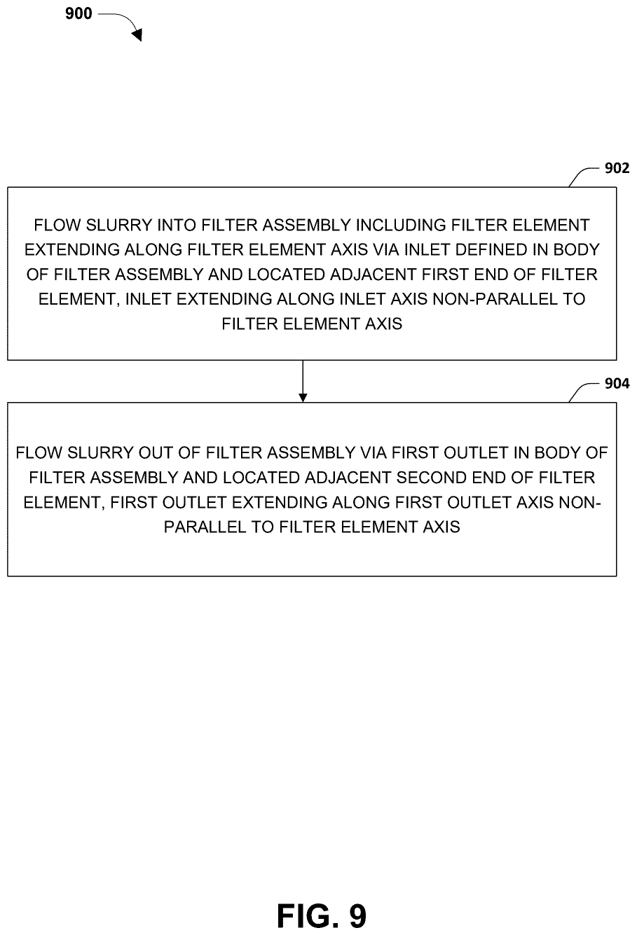

A method 900 is illustrated in FIG. 9 in accordance with some embodiments. At 902, the method 900 includes flowing base slurry into a filter assembly (e.g., the filter apparatus 300) that includes a filter element (e.g., the filter element 320) that extends along a filter element axis. The base slurry may be flowed into the filter assembly via an inlet defined in a body (e.g., the housing 310) of the filter assembly. The inlet may be located adjacent a first end of the filter element and may extend along an inlet axis that is non-parallel to the filter element axis. At 904, the method 900 includes flowing slurry out of the filter assembly via a first outlet in the body of the filter assembly and located adjacent to a second end of the filter element. The first outlet may extend along a first outlet axis that is non-parallel to the filter element axis.

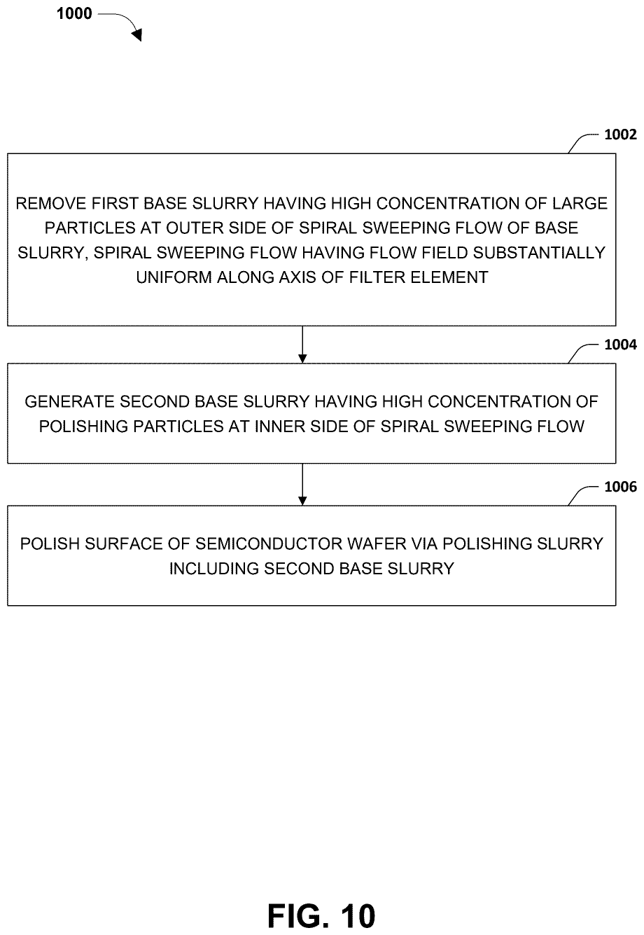

A method 1000 is illustrated in FIG. 10 in accordance with some embodiments. At 1002, the method 1000 includes removing first base slurry having high concentration of large particles, the first base slurry being at an outer side of a spiral sweeping flow (e.g., the spiral sweeping flow field 360), the spiral sweeping flow having flow field that is substantially uniform along an axis of a filter element (e.g., the filter element 320). At 1004, the method 1000 includes generating second base slurry having high concentration of polishing particles, the second base slurry being at an inner side of the spiral sweeping flow. At 1006, the method 1000 includes polishing a surface of a semiconductor wafer via polishing slurry that includes the second base slurry. It should be understood that the polishing slurry “including” the second base slurry includes the meaning that the polishing slurry is generated using the second base slurry as a constituent pre-cursor, but does not require that the second base slurry be in its identical form in the polishing slurry, for example, after aging. Namely, changes may occur to the second base slurry as a result of being included in the polishing slurry, including but not limited to at least (i) dilution, (ii) aging, (iii) breakdown and/or agglomeration of the polishing particles, etc.

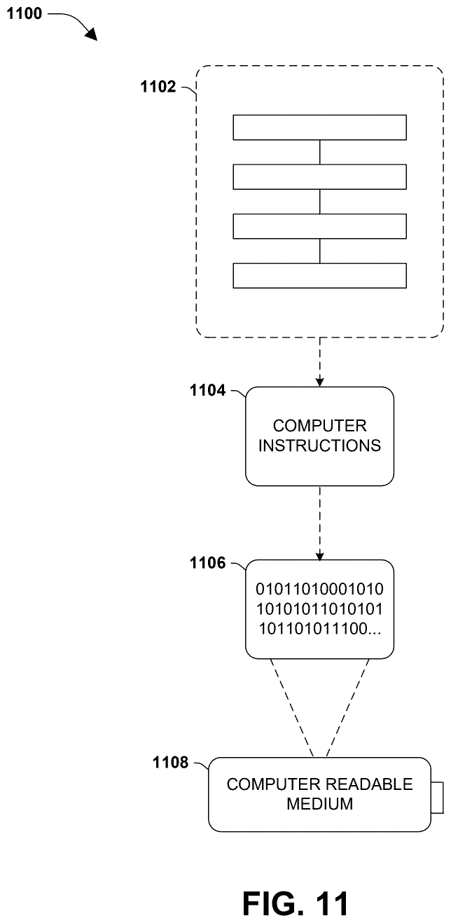

One or more embodiments involve a computer-readable medium comprising processor-executable instructions configured to implement one or more of the techniques presented herein. An exemplary computer-readable medium is illustrated in FIG. 11, wherein the embodiment 1100 comprises a computer-readable medium 1108 (e.g., a CD-R, DVD-R, flash drive, a platter of a hard disk drive, etc.), on which is encoded computer-readable data 1106. This computer-readable data 1106 in turn comprises a set of processor-executable computer instructions 1104 configured to implement one or more of the principles set forth herein when executed by a processor. In some embodiments 1100, the processor-executable computer instructions 1104 are configured to implement a method 1102, such as at least some of the aforementioned method(s) when executed by a processor. In some embodiments, the processor-executable computer instructions 1104 are configured to implement a system, such as at least some of the one or more aforementioned system(s) when executed by a processor. Many such computer-readable media may be devised by those of ordinary skill in the art that are configured to operate in accordance with the techniques presented herein.

In some embodiments, a method is provided. The method includes: flowing chemical mechanical polishing (CMP) slurry into a filter assembly, the filter assembly including a filter element extending along a filter element axis, the flowing being via an inlet defined in a body of the filter assembly and located at a first location adjacent a first end of the filter element, the inlet extending along an inlet axis non-parallel to the filter element axis; and after flowing the CMP slurry into the filter assembly, flowing the CMP slurry out of the filter assembly via a first outlet, the first outlet defined in the body of the filter assembly and located at a second location adjacent a second end of the filter element, the first outlet extending along a first outlet axis non-parallel to the filter element axis.

In some embodiments, a method is provided. The method includes: generating a spiral sweeping flow field of a base slurry in a filter apparatus, the base slurry including first base slurry at an outer region of the spiral sweeping flow field and second base slurry at an inner region of the spiral sweeping flow field; removing the first base slurry from the filter apparatus via a first outlet defined in the filter apparatus, the first base slurry having a first concentration of second particles that have dimension exceeding that of first particles; flowing the second base slurry out of the filter apparatus via a second outlet defined in the filter apparatus, the second base slurry having a second concentration of the second particles, the first concentration exceeding the second concentration; generating a polishing slurry including the second base slurry; and polishing a surface of a semiconductor wafer via the polishing slurry.

In some embodiments, a system is provided. The system includes: a first tank operable to store base slurry; a second tank operable to generate polishing slurry including filtered base slurry; and a filter apparatus operable to generate the filtered base slurry, the filter apparatus being operable to receive the base slurry from the first tank and output the filtered base slurry to the second tank. The filter apparatus includes: a housing having defined therein: an inlet connected to a first transport line; and a first outlet connected to a second transport line; and a filter element having a first end adjacent the inlet and a second end adjacent the first outlet.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments. Additionally, a variety of techniques exist for forming layers, regions, features, elements, etc. mentioned herein, such as at least one of etching techniques, planarization techniques, implanting techniques, doping techniques, spin-on techniques, sputtering techniques, growth techniques, or deposition techniques such as chemical vapor deposition (CVD), for example.

Moreover, “exemplary” and/or the like is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
flowing chemical mechanical polishing (CMP) slurry into a filter assembly, the filter assembly including a filter element extending along a filter element axis, the flowing being via an inlet defined in a body of the filter assembly and located at a first location adjacent a first end of the filter element, the inlet extending along an inlet axis non-parallel to the filter element axis; and
after flowing the CMP slurry into the filter assembly, flowing the CMP slurry out of the filter assembly via a first outlet, the first outlet defined in the body of the filter assembly and located at a second location adjacent a second end of the filter element, the first outlet extending along a first outlet axis non-parallel to the filter element axis.

2. The method of claim 1, further comprising:
during flowing the CMP slurry out of the filter assembly via the via the first outlet, flowing filtered CMP slurry out of the filter assembly via a second outlet, the second outlet defined in the body of the filter assembly and located at a third location adjacent the second end of the filter element, the second outlet extending along a second outlet axis parallel to the filter element axis.

3. The method of claim 2, wherein flowing the CMP slurry out via the first outlet is at a first flow rate and flowing the filtered CMP slurry via the second outlet is at a second flow rate, the first flow rate exceeding the second flow rate.

4. The method of claim 1, further comprising:
determining a second flow rate of the CMP slurry flowed out via the first outlet; and
selecting a first flow rate of the CMP slurry flowed in via the inlet based on the second flow rate.

5. The method of claim 1, further comprising:
determining a third flow rate of the CMP slurry flowed out via a second outlet; and
selecting a first flow rate of the CMP slurry flowed in via the inlet based on the third flow rate.

6. The method of claim 1, further comprising:
generating a spiral sweeping flow field in the CMP slurry adjacent the filter element, the spiral sweeping flow field extending from the first end of the filter element to the second end of the filter element.

7. The method of claim 6, further comprising, based on pore size of the filter element, at least one of:
adjusting a first flow rate of the CMP slurry through the inlet;
adjusting a second flow rate of the CMP slurry through the first outlet; or
adjusting a third flow rate of filtered CMP slurry through a second outlet.

8. A method comprising:
generating a spiral sweeping flow field of a base slurry in a filter apparatus, the base slurry including first base slurry at an outer region of the spiral sweeping flow field and second base slurry at an inner region of the spiral sweeping flow field;
removing the first base slurry from the filter apparatus via a first outlet defined in the filter apparatus, the first base slurry having a first concentration of second particles that have dimension exceeding that of first particles;
flowing the second base slurry out of the filter apparatus via a second outlet defined in the filter apparatus, the second base slurry having a second concentration of the second particles, the first concentration exceeding the second concentration;
generating a polishing slurry including the second base slurry; and
polishing a surface of a semiconductor wafer via the polishing slurry.

9. The method of claim 8, wherein removing the first base slurry via the first outlet includes removing the first base slurry via the first outlet that is located adjacent a base wall.

10. The method of claim 8, wherein removing the first base slurry via the first outlet includes removing the first base slurry via the first outlet that is located adjacent a cap wall.

11. The method of claim 8, further comprising:
determining, via at least one flow meter, whether a filter element of the filter apparatus is in a reduced efficacy state; and
in response to the filter element being in the reduced efficacy state, performing a reverse cleaning of the filter element.

12. The method of claim 11, wherein the performing a reverse cleaning includes:
flowing at least one of de-ionized (DI) water or nitrogen gas into the filter apparatus via the second outlet.

13. The method of claim 8, further comprising:
determining, via at least one flow meter, whether a filter element of the filter apparatus is in a reduced efficacy state; and
in response to the filter element being in the reduced efficacy state, replacing the filter element.

14. The method of claim 8, further comprising:
prior to the generating a spiral sweeping flow field, performing a pre-wash of a filter element of the filter apparatus.

15. A system, comprising:
a first tank operable to store base slurry;
a second tank operable to generate polishing slurry including filtered base slurry; and
a filter apparatus operable to generate the filtered base slurry, the filter apparatus being operable to receive the base slurry from the first tank and output the filtered base slurry to the second tank, the filter apparatus including:
a housing having defined therein:
an inlet connected to a first transport line; and
a first outlet connected to a second transport line; and
a filter element having a first end adjacent the inlet and a second end adjacent the first outlet.

16. The system of claim 15, wherein the housing includes a cap wall, a base wall and a side wall that extends from the cap wall to the base wall, the inlet is defined in the side wall adjacent to the cap wall, and the first outlet is defined in the side wall adjacent to the base wall.

17. The system of claim 16, comprising:
the first transport line in fluid communication with the first tank and the filter apparatus via the inlet;
the second transport line in fluid communication with the first tank and the filter apparatus via the first outlet; and
a third transport line in fluid communication with the second tank and the filter apparatus via a second outlet, the second outlet being defined in the base wall, the third transport line being operable to transport the filtered base slurry.

18. The system of claim 17, further comprising:
a first flow meter in fluid communication with the second transport line, the first flow meter being operable to generate a first flow rate measurement associated with the second transport line.

19. The system of claim 18, further comprising:
a second flow meter in fluid communication with the third transport line, the second flow meter being operable to generate a second flow rate measurement associated with the second transport line;
wherein the system is operable, based on at least one of the first flow rate measurement or the second flow rate measurement, to perform a reverse cleaning operation that cleans the filter element.

20. The system of claim 17, wherein the system is operable, based on a pore size of the filter element, to select at least one of:
a first flow rate in the first transport line;
a second flow rate in the second transport line; or
a third flow rate in the third transport line.
